(19) United States
(12) Patent Application Publication
(10) Pub. No.: US 2023/0090932 A1
(43) Pub. Date: Mar. 23, 2023

(54) BATTERY PACK, ELECTRIC-POWERED TOOL, AND ELECTRIC-POWERED VEHICLE

(71) Applicant: MURATA MANUFACTURING CO., LTD., Kyoto (JP)

(72) Inventor: Daiki MISAWA, Kyoto (JP)

(21) Appl. No.: 17/902,024

(22) Filed: Sep. 2, 2022

Related U.S. Application Data
(63) Continuation of application No. PCT/JP2021/007249, filed on Feb. 26, 2021.

(30) Foreign Application Priority Data
Mar. 5, 2020 (JP) 2020-037423

(51) Int. Cl. H01M 50/284; H01M 50/193; H01M 50/211; H01M 50/55; H01M 50/548; H01M 50/557; H01M 50/121; B60L 50/64

(52) U.S. Cl. CPC H01M 50/284; H01M 50/193; H01M 50/211; H01M 50/55; H01M 50/548; H01M 50/557; H01M 50/121; B60L 50/64; H01M 2220/30; H01M 2220/20

(57) ABSTRACT

A battery pack includes a secondary battery, an external case, an internal case housed inside the external case, and a circuit board, the secondary battery includes a first external terminal and a second external terminal, the first external terminal and the second external terminal are housed in the internal case, and at least the first external terminal and the second external terminal are covered with a curable resin in the internal case.

### TECHNICAL FIELD

The present invention relates to a battery pack, an electric tool, and an electric vehicle.

### BACKGROUND ART

In recent years, secondary batteries have been expanding in application. For example, lithium ion secondary batteries, which are typical examples of secondary batteries, have been expanding in application not only to various electronic devices but also to automobiles, motorcycles, electric flight vehicles, and the like. Patent Documents 1 to 3 below describe techniques for filling, with a potting resin, over the whole region of a gap inside a case included in a battery pack for ensuring and improving electrical insulation, water resistance, vibrational impact resistance, and heat dissipation of internal heat generation.

### PRIOR ART DOCUMENT

### Patent Documents

Patent Document 1: WO 2014/184993
Patent Document 2: Japanese Patent Application Laid-Open No. 2005-302382

### SUMMARY OF THE INVENTION

### Problem to be Solved by the Invention

The techniques described in the patent documents described above have, however, the following problems.

The whole inside the case is filled with the potting resin, thus increasing the weight of the battery pack. This problem becomes significant particularly in the case of a relatively large and portable battery pack with a large number of batteries mounted.

The whole inside the case is filled with the potting resin, thus increasing the material cost increasing and the filling time.

The inside of the case is filled with the potting resin without a gap, and there is thus a possibility that an impact from the outside propagates to the battery unless the impact is properly relaxed.

In addition, depending on the type of battery (for example, a laminate film-type battery cell), the size of the battery (cell) is changed and expanded with repeated charging and discharging. When the whole battery is covered with the potting resin, there is no room for allowing this change in size change, and the battery may be thus adversely affected.

Accordingly, an object of the present invention is to provide a novel and useful battery pack, electric tool, and electric vehicle that have been made in view of the issues described above.

### Means for Solving the Problem

The present invention provides a battery pack including: a secondary battery; an external case; an internal case housed inside the external case; and a circuit board, where the secondary battery includes a first external terminal and a second external terminal, the first external terminal and the second external terminal are housed in the internal case, and at least the first external terminal and the second external terminal are covered with a curable resin in the internal case.

### Advantageous Effect of the Invention

According to at least an embodiment of the present invention, the amount of the potting resin used in the battery pack can be reduced as compared with conventional cases. It is to be noted that the contents of the present invention are not to be construed as being limited by the effects illustrated in this specification.

### BRIEF EXPLANATION OF DRAWINGS

FIGS. 1A to 1C are diagrams for illustrating a secondary battery according to a first embodiment.

FIGS. 2A and 2B are diagrams for illustrating a configuration example of a battery pack according to the first embodiment.

FIGS. 3A to 3C are diagrams referred to in the description of a method for manufacturing the battery pack according to the first embodiment.

FIG. 4 is a diagram for illustrating a modification of the first embodiment.

FIGS. 5A to 5C are diagrams for illustrating a secondary battery according to a second embodiment.

FIGS. 6A to 6C are diagrams for illustrating a configuration example of a battery pack according to the second embodiment.

FIG. 7 is a diagram for illustrating a modification example.

FIGS. 8A to 8C are diagrams for illustrating a modification example.

FIG. 9 is a diagram for illustrating an application example.

FIG. 10 is a diagram for illustrating an application example.

### MODE FOR CARRYING OUT THE INVENTION

Hereinafter, embodiments and the like of the present invention will be described with reference to the drawings. It is to be noted that the description will be provided in the following order.

### <First Embodiment>

### <Second Embodiment>

### <Modification Example>

### <Application Example>

The embodiment and the like described below are preferred specific examples of the present invention, and the contents of the present invention are not to be considered limited to the embodiments and the like.

It is to be noted that the members recited in the claims are not to be considered specified as members according to the embodiment. In particular, the scope of the present invention is, unless otherwise described, not intended to be limited to only the dimensions, materials, and shapes of the constituent members described in the embodiments, the relative configurations thereof, and the description of directions such as upward, downward, leftward, and rightward directions, which are considered by way of illustrative example only. It is to be noted that sizes, positional relationships, and the like of the members illustrated in the respective drawings may be exaggerated for the clarity of description, and for preventing complicated illustrations, only some of reference numerals may be illustrated, or the illustration may be simplified in consideration of convenience of description. Furthermore, in the following description, the same names and reference numerals represent the identical or same members, and redundant descriptions thereof will be appropriately omitted. Furthermore, for each element constituting the present invention, an aspect may be employed such that one member also serves as multiple elements made of the same member, or conversely, the function of one member can be shared and achieved by a plurality of members.

### First Embodiment

### [Secondary Battery]

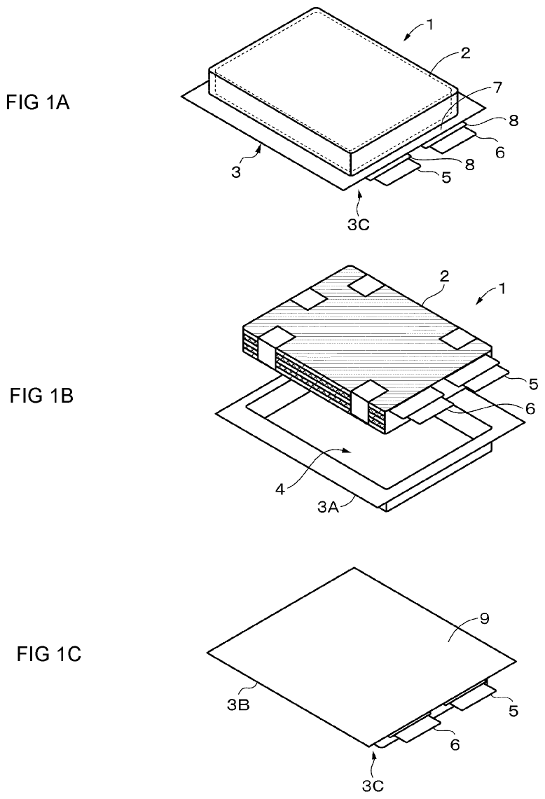

First, an example of a secondary battery applied in the present embodiment will be schematically described with reference to FIGS. 1A to 1C. The secondary battery (secondary battery 1) according to the present embodiment is, for example, a nonaqueous electrolyte secondary battery, and more specifically, is a lithium ion secondary battery of a laminate film-type secondary battery that has a flattened shape. FIG. 1A shows the appearance of the secondary battery 1, FIG. 1B is a diagram for illustrating the configuration of the secondary battery 1, and FIG. 1C is a diagram of the secondary battery 1 as viewed from below.

As shown in FIG. 1A, the secondary battery 1 has a battery element 2. The battery element 2 is externally covered with an exterior material 3. The exterior material 3 is, for example, a film-shaped laminate film. The laminate film is composed of a moisture-proof and insulating multilayer film that has an outer resin layer and an inner resin layer formed on both surfaces of a metal layer such as a metal foil. For the outer resin layer, a nylon (Ny) or a polyethylene terephthalate (PET) is used because of its beautiful appearance, toughness, flexibility, and the like. The metal foil takes on the most important role of preventing ingress of moisture, oxygen, and light and protecting the battery element 2 as a content, and aluminum (Al) is most often used therefor because of its lightness, extensibility, price, and ease of processing. The inner resin layer is a part that is melted by heat or ultrasonic waves and mutually fused, and a polyolefin-based resin material, for example, an unstretched polypropylene (CPP) is frequently used therefor. It is to be noted that the exterior material 3 may be composed of a laminate film that has another laminated structure, a polymer film such as a polypropylene, or a film-shaped exterior material such as a metal film, instead of the above-described laminate film.

The exterior material 3 has a first exterior material 3A and a second exterior material 3B. As shown in FIG. 1B, the first exterior material 3A has a recess 4 formed by applying a deep drawing process, an embossing process, or the like in advance to at least one surface of the first exterior material 3A. The battery element 2 is housed in the recess 4. The second exterior material 3B is disposed so as to cover the opening of the recess 4 with the battery element 2 housed therein, and the periphery of the opening of the recess 4 is sealed by thermal fusion bonding or the like (see FIG. 1C).

The battery element 2 has a stacked electrode structure including a positive electrode and a negative electrode alternately stacked with a separator interposed therebetween. The battery element 2 may include an electrolyte. In this case, for example, in the battery element 2, an electrolyte (electrolyte layer) may be formed at least either between the positive electrode and the separator or between the negative electrode and the separator. The electrolyte is, for example, an electrolytic solution held in a polymer compound, and is, for example, a gel-like electrolyte. It is to be noted that in the case of using, as the electrolyte, an electrolytic solution as a liquid electrolyte, no electrolyte layer is formed, and the battery element 2 is impregnated with an electrolytic solution filling in the exterior material 3.

A positive electrode tab 5 as a first external terminal is connected to a positive electrode current collector exposed part of the battery element 2 by a method such as ultrasonic welding or resistance welding. In addition, a negative electrode tab 6 as a second external terminal is connected to a negative electrode current collector exposed part of the battery element 2 by a method such as ultrasonic welding or resistance welding. For example, a metal lead body (metal tab) made of aluminum (Al), nickel (Ni), or the like can be used as the positive electrode tab 5 and the negative electrode tab 6.

The positive electrode tab 5 and the negative electrode tab 6 are led out toward the outside from a side surface 3C that is one side surface of the sealing part of the exterior material 3. The positive electrode tab 5 and the negative electrode tab 6 are led out in the same direction from the side surface 3C toward the outside. The sealing region along the side from which the positive electrode tab 5 and the negative electrode tab 6 are led out is referred to as a terrace part 7. In addition, the side surface 3C is small in thickness, and thus actually in the form of a side.

It is to be noted that a part of the positive electrode tab 5 is provided with an adhesive film 8 for improving the adhesion between the exterior material 3 and the positive electrode tab 5. The adhesive film 8 is made of a resin material that has high adhesiveness to a metal material, and for example, when the positive electrode tab 5 is made of the metal material described above, the adhesive film 8 is preferably made of a polyolefin resin such as a polyethylene, a polypropylene, a modified polyethylene, or a modified polypropylene. Similarly, a part of the negative electrode tab 6 is also provided with the adhesive film 8.

It is to be noted that a face that has the largest area, of the outer surface of the secondary battery 1, is appropriately referred to as a main surface 9 of the secondary battery 1 in the following description. According to the present embodiment, the surface of the second exterior material 3B opposite to the surface in contact with the battery element 2 (the bottom surface of the secondary battery 1) corresponds to the main surface 9 of the secondary battery 1.

### [Battery Pack]

### Overall Configuration Example

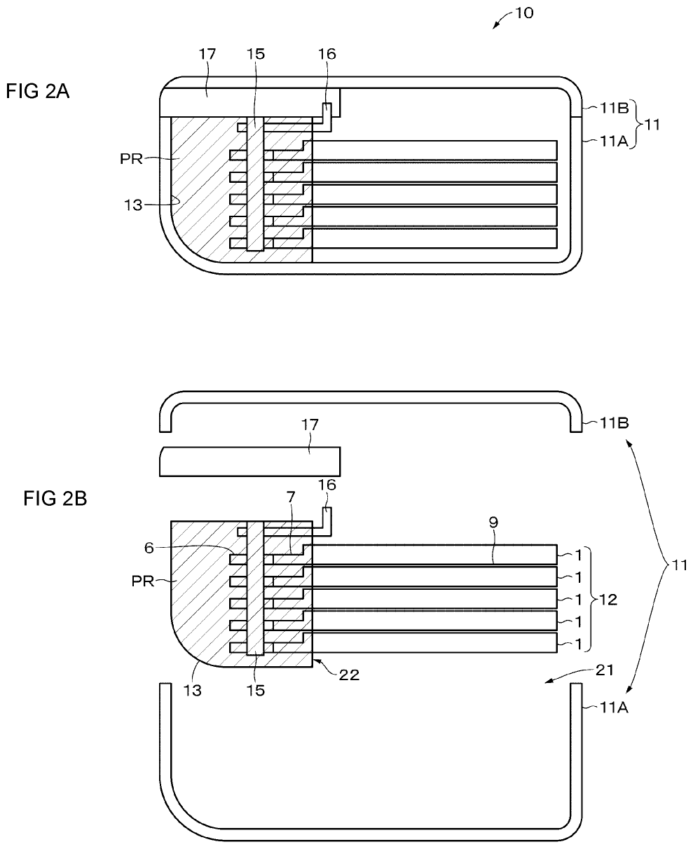

Next, a configuration example of a battery pack (battery pack 10) according to the present embodiment will be described with reference to FIGS. 2A and 2B. FIG. 2A is a view of the battery pack 10 as viewed from a side-surface direction (a view seen through the inside of the case), and FIG. 2B is an exploded view that relates to a main configuration of the battery pack 10.

The battery pack 10 has a box-shaped external case 11. The external case 11 is made of resin or the like. The external case 11 has a configuration obtained by fitting a lower case 11A, which is an example of a first external case, and an upper case 11B, which is an example of a second external case. The lower case 11A and the upper case 11B are fitted by an appropriate method with a screw or the like used. The lower case 11A is formed deeper than the upper case 11B. The lower case 11A has an open opening face 21 on the upper side (see FIG. 2B).

In the external case 11, a battery unit (also referred to as a core pack or the like) 12 is housed. The battery unit 12 includes one or more secondary batteries. As the secondary batteries, the secondary battery 1 described above can be applied. According to the present embodiment, the battery unit 12 has a configuration with five secondary batteries 1 arranged so as to be stacked in the lower case 11A. Furthermore, according to the present embodiment, each secondary battery 1 is housed such that the main surface 9 of each secondary battery 1 is substantially parallel to the opening face 21 of the lower case 11A.

In addition, the battery pack 10 has the external case 11, more specifically, an internal case 13 housed in the lower case 11A. The internal case 13 has a box shape with an opening face 22 such that the case alone has one predetermined face open, and has a shape following the inner surface shape of the lower case 11A. Such a shape allows, as shown in FIG. 2B, the gap between lower case 11A and the internal case 13 to be eliminated as much as possible. In addition, positioning of the internal case 13 can be facilitated.

The battery pack 10 includes a circuit board 15, a bus bar 16, and a connector 17. The circuit board 15 and a part of the bus bar 16 are housed in the internal case 13. The positive electrode tab 5 and negative electrode tab 6 of the secondary battery 1 are connected to the circuit board 15. The electrical connection mode of the circuit board 15 will be described later. The circuit board 15 has an IC (Integrated Circuit) mounted to operate for protecting the battery unit 12 (overcharge prevention function, overdischarge prevention function, overcurrent interruption function) and the like.

The bus bar 16 has one side housed inside the internal case 13, and the other side exposed to the outside of the internal case 13. An exposed tip of the bus bar 16 is connected to the connector 17. The connector 17 has an output terminal (not shown) exposed to the outside of the external case 11. Power of the battery unit 12 is supplied to an output terminal of the connector 17 via the circuit board 15 and the bus bar 16, and is supplied to an external load via the output terminal of the connector 17.

### Connection Configuration Example

Next, a mode of connecting the five secondary batteries 1 and a mode of connecting the battery unit 12 to the circuit board 15 will be described. The five secondary batteries 1 are connected in series, for example. Specifically, the positive electrode tab 5 of the secondary battery 1 of the topmost layer (the secondary battery 1 shown on the uppermost side among the five secondary batteries 1 shown in FIG. 2B) is connected to the circuit board 15. Next, the negative electrode tab 6 of the secondary battery 1 is connected to the positive electrode tab 5 of the secondary battery 1 of the next adjacent layer (the secondary battery 1 shown second from the upper side among the five secondary batteries 1 shown in FIG. 2B) via a metal plate or the like. As described above, the positive electrode tabs 5 and negative electrode tabs 6 of the adjacent secondary batteries 1 are alternately connected. Finally, the negative electrode tab 6 of the secondary battery 1 of the bottommost layer (the secondary battery 1 shown on the lowermost side among the five secondary batteries 1 shown in FIG. 2B) is connected to the circuit board 15.

It is to be noted that according to the present embodiment, the connection site (intermediate potential) of the adjacent secondary batteries 1 is connected to the circuit board 15 via a predetermined metal plate. Such a configuration allows the voltage of each secondary battery 1 to be measured. Obviously, a configuration may be employed in which only the positive electrode tab 5 of the secondary battery 1 located in the topmost layer and the negative electrode tab 6 of the secondary battery 1 located in the bottommost layer are connected to the circuit board 15. It is to be noted that FIGS. 2A and 2B show only the negative electrode tab 6 connected to the circuit board 15, without any positive electrode tab 5 shown in the drawings, because of the viewing direction.

### (Potting Resin)

The internal case 13 is filled with a potting resin PR as a curable resin. The potting resin is a potting material in the case of requiring waterproofness, or protecting a site that is mechanically weak against an impact. The potting resin in the form of a paste or a liquid at the time of injection is cured after the injection to lose the fluidity. In FIGS. 2A and 2B, the cured potting resin PR is shown. As the potting resin PR, a urethane resin, an epoxy resin, a silicon resin, or the like can be used.

Each structure housed in the internal case 13 is covered with a potting resin PR. In FIGS. 2A and 2B, the part covered with the potting resin PR is hatched. Specifically, the circuit board 15 and the part of the bus bar 16 housed in the internal case 13 are covered with the potting resin PR. In addition, the connection site between the battery unit 12 and the circuit board 15, where the mechanical strength is likely to be fragile, is covered with the potting resin PR. According to the present embodiment, the positive electrode tab 5 and negative electrode tab 6 of each secondary battery 1 are connected to the circuit board 15, and at least the positive electrode tab 5 and the negative electrode tab 6 are thus covered with the potting resin PR in the internal case 13. According to the present embodiment, furthermore, for enhancing the impact resistance of the connection site described above, the part including: the side surface 3C from which the positive electrode tab 5 and the negative electrode tab 6 are led out; and the terrace part 7 is also covered with the potting resin PR.

### (Manufacturing Method)

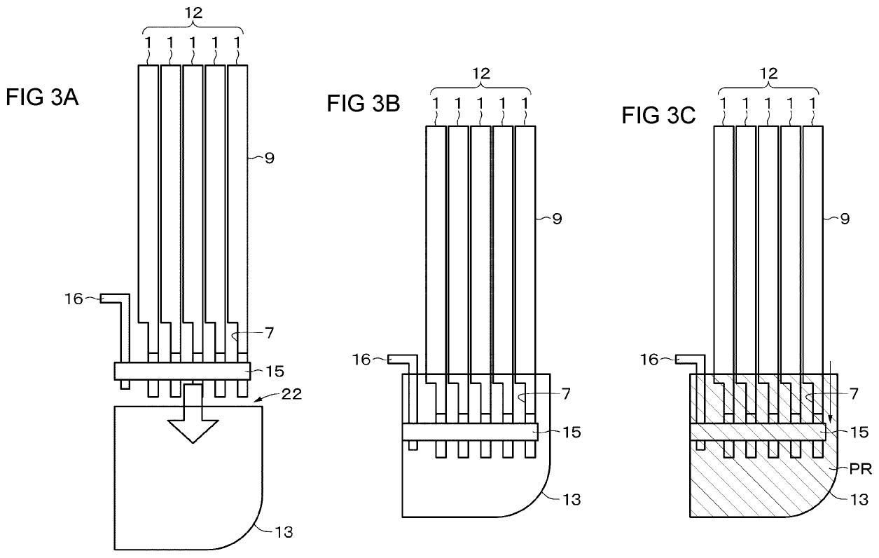

Next, an example of a method for manufacturing the battery pack 10 according to the present embodiment will be described with reference to FIGS. 3A to 3C. First, the respective secondary batteries 1 and the bus bar 16 are connected to the circuit board 15. Then, as shown in FIG. 3A, the circuit board 15, the positive electrode tab 5 and negative electrode tab 6 of each secondary battery 1 connected to the circuit board 15, the side surface 3C and terrace part 7 of each secondary battery 1, and a part of the bus bar 16 are housed in the internal case 13 through the opening face 22. As shown in FIG. 3B, with the circuit board 15 and the like housed in the internal case 13, the flowable potting resin PR is provided for filling through the opening face 22. As shown in FIG. 3C, the potting resin PR is cured, thereby covering the configuration in the internal case 13 with the potting resin PR while blocking the opening face 22. After the potting resin PR is cured, the internal case 13 is housed so as to follow the inner surface of the lower case 11A while appropriately changing the direction of the unit shown in FIG. 3C. Finally, the lower case 11A and the upper case 11B are fitted to finish the battery pack 10.

### (Effects Obtained by Present Embodiment)

According to the present embodiment, for example, the following effects can be obtained.

The battery pack 10 according to the present embodiment eliminates the need to fill the whole region in the external case 11 with the potting resin PR, thus allowing the amount of potting resin PR used to be reduced.

In this regard, based on the viewpoint of reducing the amount of the potting resin PR used, it is also conceivable to fill only the connection site between the battery unit 12 and the circuit board 15 with the potting resin PR without using the internal case 13 in the arrangement of the respective structures shown in FIG. 2A. If the potting resin PR is provided for filling through the opening face 21 of the lower case 11A, the potting resin PR flows out to the bottom surface of the lower case 11A because the potting resin PR is flowable. For this reason, the necessary part fails to be covered with the potting resin PR. According to the present embodiment, however, the use of the internal case 13 allows the retention therein of the potting resin PR, thus allowing only a necessary part that requires electrical insulation, water resistance, impact resistance, heat dissipation, and the like to be reliably covered with the potting resin PR.

The amount of the potting resin PR used can be reduced, thus allowing the manufacturing cost of the battery pack 10 to be reduced, and allowing the weight of the battery pack 10 to be reduced.

In addition, the use of the internal case 13 allows a buffer part to be provided between the external case 11 and the battery unit 12, and allows the impact resistance of the whole battery pack 10 to be improved.

In addition, the shape of the internal case 13 is made to follow the inner surface shape of the external case 11, thereby allowing the gap (backlash) between the internal case 13 and the external case 11 to be reduced as much as possible, and thus allowing the impact resistance of the whole battery pack 10 to be improved.

In addition, when the secondary battery 1 is a laminate film-type battery, the secondary battery 1 undergoes a change in size due to repeated charging and discharging. If the whole secondary battery 1 is covered with the potting resin PR, the change in the outer shape of the secondary battery 1 may fail to be allowed, and the secondary battery 1 may be possibly damaged. According to the present embodiment, a part of the secondary battery 1 rather than the whole secondary battery 1 is covered with the potting resin PR. Specifically, the battery element 2 included in the secondary battery 1 is not covered with the potting resin PR. Thus, a structure that allows a change in the outer shape of the secondary battery 1 can be provided, and thus, the above-described problem can be avoided.

### Modification Example of First Embodiment

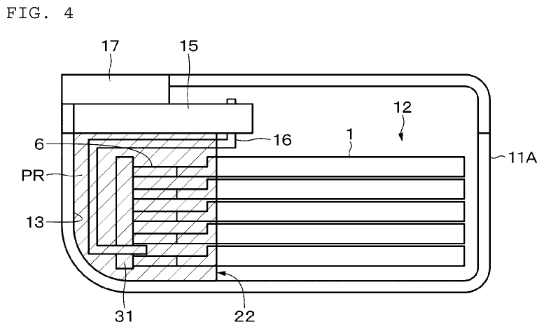

As shown in FIG. 4, the circuit board 15 is not necessarily covered with the potting resin PR. In the case of such a configuration, as shown in FIG. 4, a terminal aggregation part 31 is provided, and the positive electrode tab 5, the negative electrode tab 6, and the site at the intermediate potential are connected to the terminal aggregation part 31. Further, the terminal aggregation part 31 is connected to the circuit board 15 via the bus bar 16. The power of the battery unit 12 is extracted to the outside via the connector 17 connected to the circuit board 15. At least a part of the bus bar 16 (specifically, the part of the bus bar 16 excluding a part thereof led out from the internal case 13, required for connecting the bus bar 16 to the circuit board 15) and the terminal aggregation part 31 are covered with the potting resin PR.

The part most damaged when the battery pack 10 is subjected to an impact vibration is the part connecting the battery unit 12 and the circuit board 15, or the terminal aggregation part 31 to which the positive electrode tab and the negative electrode tab are connected. As in the present modification example, the terminal aggregation part 31 for connecting the secondary batteries 1 to each other, and at least a part of the connection including the connection site between the bus bar 16 for the connection to the circuit board 15 and the terminal aggregation part 31 are reliably covered and fixed with the potting resin PR, thereby making it possible to reduce stress on a site that is likely to be damaged by an impact, and thus making it possible to prevent the bus bar 16 from being broken.

### Second Embodiment

Next, a second embodiment will be described. It is to be noted that in the description of the second embodiment, the identical or same configurations in the description of the first embodiment described above are denoted by the same reference numerals, and redundant descriptions thereof will be appropriately omitted. In addition, unless otherwise specified, the matters described in the first and second embodiments can be applied to the second embodiment.

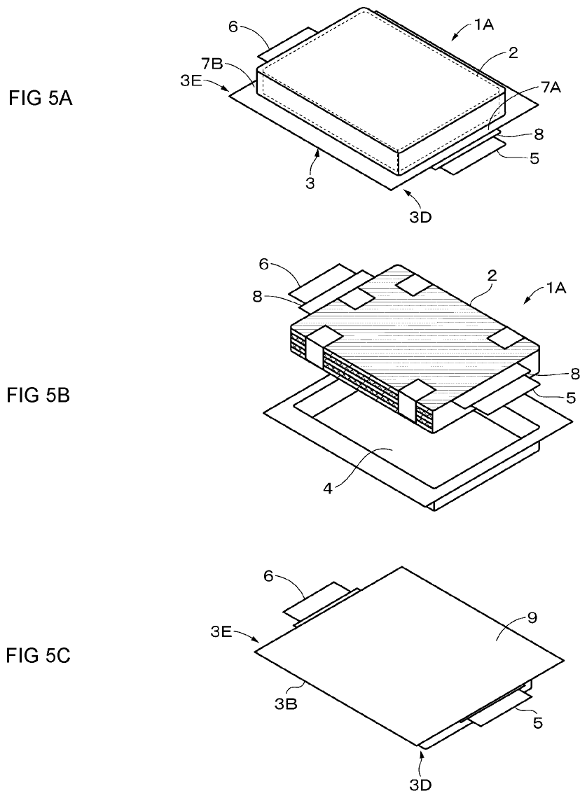

The second embodiment differs from the first embodiment in the configuration of the secondary battery. An example of a secondary battery (secondary battery 1A) applied in the present embodiment will be schematically described with reference to FIGS. 5A to 5C.

The secondary battery 1A differs from the secondary battery 1 according to the first embodiment in that the positive electrode tab 5 and the negative electrode tab 6 are led out from the same side surface (side surface 3C) for the secondary battery 1, whereas the tabs are led out from the opposite side surfaces for the secondary battery 1A. Specifically, the positive electrode tab 5 is led out from the side surface 3D, and the negative electrode tab 6 is led out from the side surface 3E that is a side surface opposite to the side surface 3D. The welded site close to the positive electrode tab 5 is a terrace part 7A, and the welded site close to the negative electrode tab 6 is a terrace part 7B. The other configuration of the secondary battery 1A is basically similar to that of the secondary battery 1.

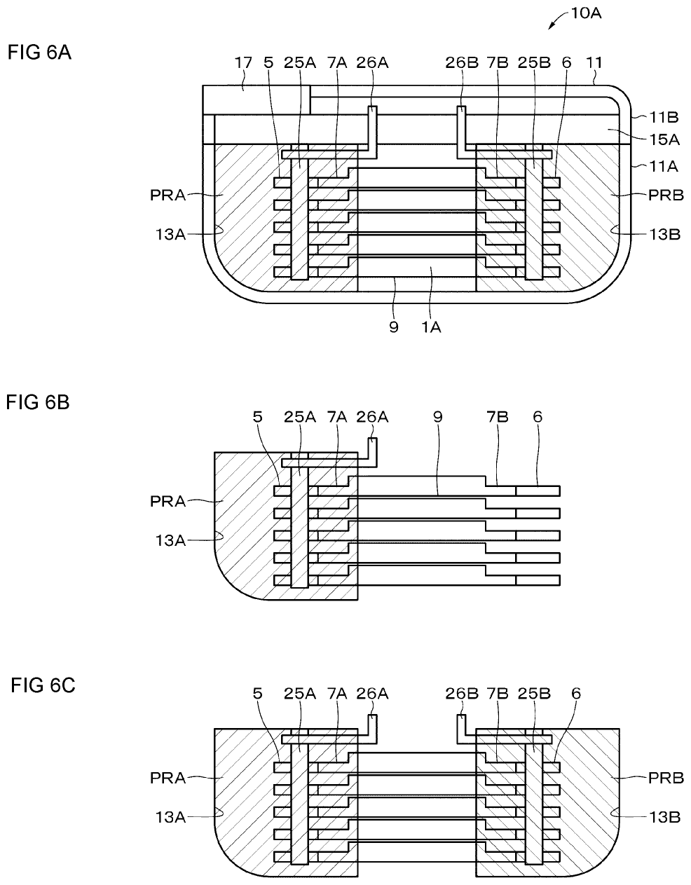

A configuration example and the like of a battery pack (battery pack 10A) according to the second embodiment will be described with reference to FIGS. 6A to 6C. FIG. 6A is a view of the battery pack 10A as viewed from a side-surface direction (a view seen through the inside of the case), and FIGS. 6B and 6C are diagrams for illustrating an example of a method for manufacturing the battery pack 10A. According to the second embodiment, for example, five secondary batteries 1A stacked are connected in series.

As shown in FIG. 6A, the positive electrode tab 5 of each secondary battery 1A is connected to a positive electrode tab aggregation part 25A made from a metal plate or the like. In addition, one end side of a bus bar 26A is connected to the positive electrode tab aggregation part 25A. The other end side of the bus bar 26A is connected to a circuit board 15A.

The negative electrode tab 6 of each secondary battery 1A is connected to a negative electrode tab aggregation part 25B made from a metal plate or the like. In addition, one end side of a bus bar 26B is connected to the negative electrode tab aggregation part 25B. The other end side of the bus bar 26B is connected to the circuit board 15A.

The circuit board 15A and a connector 17 are connected by the bus bar (not shown) or the like, thereby allowing the power of the five secondary batteries 1A to be extracted to the outside of the battery pack 10A.

Also in the battery pack 10A according to the present embodiment, internal cases are housed in a lower case 11A. According to the second embodiment, two internal cases (an internal case 13A and an internal case 13B) are disposed on both sides that respectively have the electrode tabs (the positive electrode tab 5 and the negative electrode tab 6). Each of the internal case 13A and the internal case 13B has a shape following the inner surface shape of the lower case 11A. It is to be noted that according to the present embodiment, the circuit board 15A is housed outside the internal case 13A and the internal case 13B in the external case 11.

The internal case 13A is filled with a potting resin PRA. Thus, the configuration housed in the internal case 13A is covered with the potting resin PRA. At least the positive electrode tab 5 connected to the positive electrode tab aggregation part 25A is covered with the potting resin PRA. More specifically, the positive electrode tab 5 connected to the positive electrode tab aggregation part 25A, the terrace part 7A including the side surface 3D, the positive electrode tab aggregation part 25A, and a part of the bus bar 26A disposed in the internal case 13A are covered with the potting resin PRA.

The internal case 13B is filled with a potting resin PRB. Thus, the configuration housed in the internal case 13B is covered with the potting resin PRB. At least the negative electrode tab 6 connected to the positive electrode tab aggregation part 25B is covered with the potting resin PRB. More specifically, the negative electrode tab 6 connected to the negative electrode tab aggregation part 25B, the terrace part 7B including the side surface 3E, the negative electrode tab aggregation part 25B, and a part of the bus bar 26B disposed in the internal case 13B are covered with the potting resin PRB.

An example of a method for manufacturing the battery pack 10A will be described. As shown in FIG. 6B, the positive electrode tab 5 connected to the positive electrode tab aggregation part 25A, the terrace part 7A including the side surface 3D, the positive electrode tab aggregation part 25A, and a part of the bus bar 26A disposed in the internal case 13 are housed in one internal case 13A, the internal case 13A is then covered with the potting resin PRA. After the potting resin PRA is cured, as shown in FIG. 6C, the negative electrode tab 6 connected to the negative electrode tab aggregation part 25B, the terrace part 7B including the side surface 3E, the negative electrode tab aggregation part 25B, and a part of the bus bar 26B disposed in the internal case 13 are housed in the opposite internal case 13B, and the internal case 13B is covered with the potting resin PRB. After the potting resin PRB is cured, the unit shown in FIG. 6C is housed in the lower case 11A, and the lower case 11A and the upper case 11B are fitted to each other to finish the battery pack 10A.

As described above, the present invention can also be applied to the battery pack 10A including the secondary battery 1A used with the positive electrode tab 5 and the negative electrode tab 6 led out from the opposite sides.

### Modification Example

While the embodiments of the present invention have been concretely described above, the contents of the present invention are not to be considered limited to the embodiments described above, and it is possible to make various modifications based on the technical idea of the present disclosure.

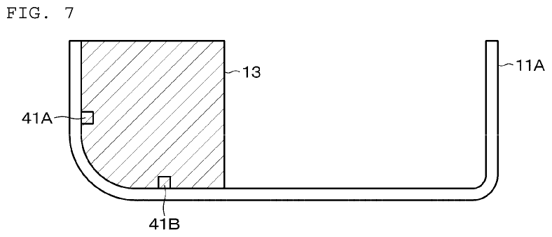

The inner surface (the site in contact with the internal case 13) of the lower case 11A of the external case 11 may be provided with a rib (protruding structure). For example, as shown in FIG. 7, the inner surface of lower case 11A may be provided with a rib 41A and a rib 41B. The ribs are provided, thereby allowing the internal case 13 to be more firmly fixed. It is to be noted that the number of ribs and the positions at which the ribs are provided can be set appropriately.

When the materials of the external case 11 and internal case 13 meet the hardness in the external case 11 >the hardness of the internal case 13, it is possible to expect the effect of filling, at the time of fixing, a slight gap produced from variations in shape between the components. More specifically, the external case 11 and the internal case 13 are disposed such that a pressure is applied to the internal case 13 from the inside thereof toward the outside thereof when the lower case 11A and the upper case 11B are fitted to each other, thereby allowing the degree of close contact between the external case 11 and the internal case 13 to be increased, and allowing the gap between the external case 11 and the internal case 13 to be reduced as much as possible. Thus, if an impact or a vibration is applied to the battery pack 10, the movement of the battery unit 12 inside the case can be suppressed, and the durability can be enhanced.

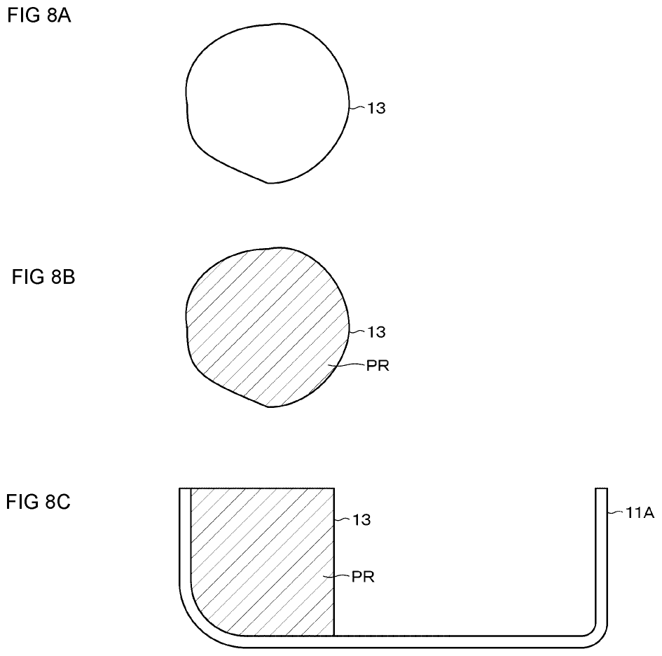

The difference in hardness between the materials applies to not only the internal case 13, and the use of the curing property of the potting resin PR allows the close contact to be further enhanced. For example, as shown in FIG. 8A, the internal case 13 is formed from a deformable ultra-thin film-shaped material (specifically, a film-shaped resin), and the internal case 13 is filled with the potting resin PR. The potting resin PR, which is cured by heat, two-liquid mixing, or the like, is low in viscosity at the time of filling, and cured with time. The internal case 13 is incorporated into the lower case 11A at the timing of such a viscosity (temporary curing) at which the potting resin PR can be handled after being left for a while after the filling with the potting resin PR. The internal case 13 is a film-shaped material, and is thus deformed into a shape that follows the inner surface shape of the external case 11. The potting resin PR is cured with the internal case 13 deformed, thereby allowing the close contact between the external case 11 and the internal case 13 to be more reliably enhanced. It is to be noted that in the present example, a part of the internal case 13 out of contact with the inner surface of the external case 11 may be molded into an appropriate shape by using an appropriate jig or the like. The close contact between the external case 11 and the internal case 13 is improved, thereby allowing heat generated in the circuit board 15, the secondary battery 1, or the like to be transferred from the internal case 13 to the external case 11 through the potting resin PR, and allowing the heat dissipation of the battery pack to be improved. In addition, the close between the external case 11 and the internal case 13 is improved, thereby allowing the thermal resistance at the time of heat transfer to be reduced, and allowing the heat dissipation effect into the air to be further improved.

The internal case 13 and the lower case 11A may be fixed by screw fixing or bond fixing, or may be fixed so as to be sandwiched between the lower case 11A and the upper case 11B.

While the main surface 9 of the secondary battery 1 is substantially parallel to the opening face 21 of the lower case 11A in the embodiment described above, the main surface 9 of the secondary battery 1 may be disposed to be substantially perpendicular to the opening face 21 of the lower case 11A.

As the present invention, a battery other than the battery of the laminate film-type battery, for example, a rectangular secondary battery can be applied.

### Application Example

The battery packs 10 and 10A according to the present invention can be used for mounting on an electric tool, an electric vehicle, various electronic devices, or the like, or for supplying electric power thereto.

### (Electric Tool)

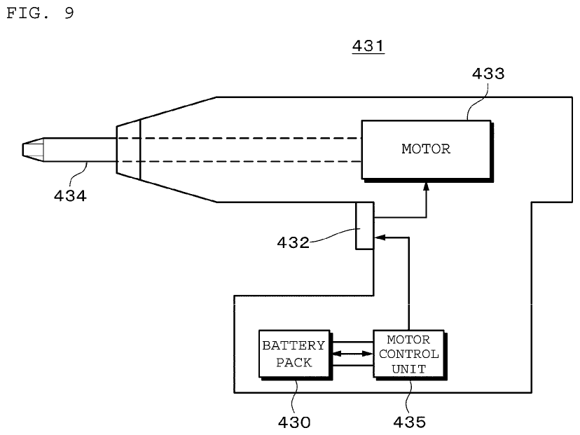

An example of an electric driver as an electric tool to which the present invention can be applied will be schematically described with reference to FIG. 9. An electric driver 431 is provided with a motor 433 that transmits rotative power to a shaft 434 and a trigger switch 432 operated by a user. A battery pack 430 and a motor control unit 435 are housed in a lower housing of a handle of the electric driver 431. The battery pack 430 is built in the electric driver, or detachable from the electric driver 431. The battery pack 10 or 10A described above can be applied to the battery pack 430.

The battery pack 430 and the motor control unit 435 each may include a microcomputer (not shown), such that charge/discharge information of the battery pack 430 can be communicated with each other. The motor control unit 435 can control the operation of the motor 433, and cut off the power supply to the motor 433 at the time of abnormality such as overdischarge.

### (Electric Storage System for Electric Vehicle)

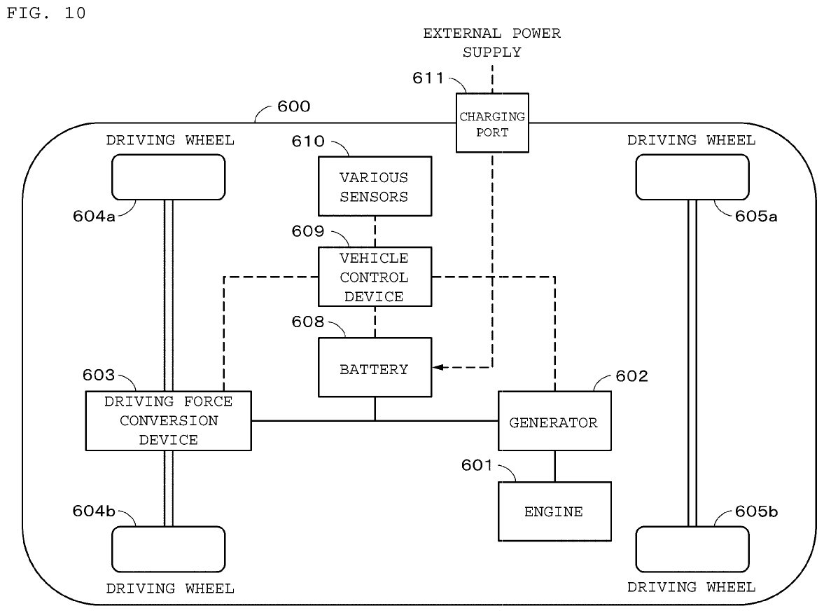

FIG. 10 schematically illustrates a configuration example of a hybrid vehicle (HV) that employs a series hybrid system to which the present invention is applied, as an example of applying the present invention to an electric storage system for an electric vehicle. The series hybrid system is intended for a vehicle that runs on an electric power-driving force conversion device, with the use of electric power generated by a generator powered by an engine, or the electric power stored once in the battery.

The hybrid vehicle 600 carries an engine 601, a generator 602, the electric power-driving force conversion device 603 (direct-current motor or alternate-current motor, hereinafter referred to simply as a “motor 603”), a driving wheel 604a, a driving wheel 604b, a wheel 605a, a wheel 605b, a battery 608, a vehicle control device 609, various sensors 610, and a charging port 611. As the battery 608, the battery pack 10 or 10A according to the present invention or an electric storage module mounted with a plurality of battery packs according to the present invention can be applied.

The motor 603 is operated by the electric power of the battery 608, and the torque of the motor 603 is transmitted to the driving wheels 604a and 604b. The torque produced by the engine 601 makes it possible to reserve, in the battery 608, the electric power generated by the generator 602. The various sensors 610 control the engine rotation speed via the vehicle control device 609, and control the position of a throttle valve, not shown.

When the hybrid vehicle 600 is decelerated by a braking mechanism, not shown, the resistance force during the deceleration is applied as torque to the motor 603, and the regenerative electric power generated by the torque is reserved in the battery 608. The battery 608 is connected to an external power supply through the charging port 611 of the hybrid vehicle 600, thereby making charge possible. Such an HV vehicle is referred to as a plug-in hybrid vehicle (PHV or PHEV).

It is to be noted that the secondary battery according to the present invention can also be applied to a downsized primary battery, and then used as a power supply for a pneumatic sensor system (TPMS: Tire Pressure Monitoring System) built in the wheels 604 and 605.

Although the series hybrid vehicle has been described above as an example, the present invention can be also applied to a parallel system in which an engine and a motor are used in combination or a hybrid vehicle in which a series system and a parallel system are combined. Furthermore, the present invention can be also applied to electric vehicles (EVs or BEVs) that run on driving by only a driving motor without using any engine, and fuel cell vehicles (FCVs).

### DESCRIPTION OF REFERENCE SYMBOLS

1, 1A: Secondary battery
3C, 3D, 3E: Side surface
5: Positive electrode tab
6: Negative electrode tab
10, 10A: Battery Pack
11: External case
11A: Lower case
11B: Upper case
13, 13A, 13B: Internal case
15, 15A: Circuit board
16: Bus bar
21: Opening face
41A, 41B: Rib
PR, PRA, PRB: Potting resin

1. A battery pack comprising:
a secondary battery;
an external case;
an internal case housed inside the external case; and a circuit board,
wherein
the secondary battery includes a first external terminal and a second external terminal,
the first external terminal and the second external terminal are housed in the internal case, and
at least the first external terminal and the second external terminal are covered with a curable resin in the internal case.

2. The battery pack according to claim 1, wherein
the secondary battery is a flattened laminate film-type secondary battery, and
the external case houses therein a plurality of secondary batteries stacked.

3. The battery pack according to claim 2, wherein
the first external terminal and the second external terminal each include a metal tab led out from one side surface of the secondary battery, and
the first external terminal, the second external terminal, and the one side surface of the secondary battery are covered with the curable resin.

4. The battery pack according to claim 2, wherein
the external case has a configuration with a first external case and a second external case fitted to each other, and
the internal case and the secondary battery are housed in the first external case, and
a main surface of the secondary battery is housed to be substantially parallel to an opening face of the first external case.

5. The battery pack according to claim 2, wherein
the external case has a configuration with a first external case and a second external case fitted to each other,
the internal case and the secondary battery are housed in the first external case, and
a main surface of the secondary battery is housed to be substantially perpendicular to an opening face of the first external case.

6. The battery pack according to claim 1, wherein
the circuit board is housed together with the secondary battery in the internal case, and
at least a part of the circuit board is covered with the curable resin.

7. The battery pack according to claim 1, wherein at least a part of a connection electrically connecting the circuit board and the secondary battery is covered with the curable resin.

8. The battery pack according to claim 4, wherein an outer shape of the internal case has a shape that follows an inner surface shape of the first external case.

9. The battery pack according to claim 1, wherein the internal case includes a deformable film-shaped resin.

10. The battery pack according to claim 8, wherein at least one protrusion is formed at a site of the external case in contact with the internal case.

11. An electric tool comprising the battery pack according to claim 1.

12. An electric vehicle comprising the battery pack according to claim 1.
